(19) United States
(12) Patent Application Publication
(10) Pub. No.: US 2010/0201667 A1
(43) Pub. Date: Aug. 12, 2010

(54) METHOD AND SYSTEM FOR DISPLAY CHARACTERIZATION AND CONTENT CALIBRATION

(76) Inventors: Bongsun Lee, La Crescenta, CA (US); Ingo Tobias Doser, Burbank, CA (US)

Correspondence Address: Robert D. Shedd, Patent Operations;THOMSON Licensing LLC, P.O. Box 5312, Princeton, NJ, 08543-5312, US

(21) Appl. No.: 12/452,131

(22) PCT Filed: Jun. 18, 2007
(86) PCT No.: PCT/US2007/014288

§ 371 Date: Apr. 12, 2010

(51) Int. Cl. G09G 5/00

(52) U.S. Cl. 345/211

(57) ABSTRACT

A method and system for characterization of a display for facilitating the calibration of the display values of input content in response to dynamic behavior caused by changes in average power (picture) level of the input content include determining a level of average power (APL) in the input content and applying a transform to the input content to determine display values for the input content based on the determined APL of the input content. The transform, in one embodiment of the invention is based on a display characterization which includes a measurement of at least one APL on the display. In one embodiment of the present invention, the transform is a four dimensional look-up table that maps input content color values to respective human visual system values for different average power levels.

### TECHNICAL FIELD

The present invention generally relates to display calibration, and more particularly, to a system and method for characterizing a display in instances in which the display values vary with a change in the average power (or picture) levels (APL) of input content.

### BACKGROUND

Certain flat panel displays (e.g., Plasma TVs) have dynamic behavior which changes according to input content. Most display variations include the change of brightness, contrast ratio, color gamut, and gamma characteristics, and these variations depend on levels or powers of the content. This makes it difficult to perform a general display calibration.

A conventional method of characterizing a display is to measure patches on the display using a spectroradiometer. Once the measurement data are available (i.e., colorimetric data (CIE XYZ)), then a relation between RGB color components (e.g., red, green, blue) of the patches and the measured human visual tristimulus values (XYZ) are calculated.

CIE XYZ or XYZ for short represents the CIE XYZ color-space created by the CIE (Commission Internationale de l'Eclairage). The color vision of a group of people was tested and a model for human visual perception called the CIE Standard Observer was created based on those tests. The CIE XYZ color-space was then created by combining the well known physical properties of light and the characteristics and restrictions/boundaries of the human visual perception for the CIE Standard Observer.

One typical form of the relationship or mapping between color components (RGB) of the patches and the human visual tristimulus values (XYZ) is to use a 3D LUT (three dimensional look-up table). Then, the LUT is applied to the input content and its signal is corrected to be adapted to the display being measured.

However, for a display with dynamic behavior, this method may not work since the characteristics of the display change with different average power (or picture) levels (APLs). The display characteristics can be measured for other levels, but there is a limitation on the number of measurements (i.e. the number of APLs). Therefore, a system and method to provide a precise display calibration for any arbitrary APL is needed.

Flat panel displays often show dynamic features such as dynamic contrast, brightness, and dynamic APL. These advanced processing features help the displays produce more enhanced image quality because brightness, contrast, gammas, etc. are adapted to the input content in real time. However, from the calibration point of view, applying one calibration derived for a given level (e.g. fixed APL) to another level may not work due to discrepancies of display characteristics among different levels and display types (i.e., display behavior changes dynamically according to average power levels (or average picture levels) of the input content).

### SUMMARY

A method and system in accordance with various embodiments of the present invention address the deficiencies of the prior art by providing a novel approach to characterizing a display and calibrating input content in response to dynamic behavior caused by changes in average power (picture) level of the input content.

In one embodiment of the present invention, a method for input content display calibration includes determining an average power level (APL) of the input content and applying a transform to the input content to determine display values for the input content based on the determined APL of the content, the transform in one embodiment being based on a display characterization which includes a measurement of a plurality of average power levels on the display. The transform, in one embodiment of the invention is based on a display characterization which includes a measurement of a plurality of average power levels on the display. In one embodiment of the present invention, the transform is a four dimensional look-up table that maps input content color values to respective human visual system values for different average power levels.

In an alternate embodiment of the present invention, a method for characterizing a display to adapt to changes in average power level (APL) of input content includes measuring a color component response of the display for at least one average power level (APL), generating a look-up table for the at least one APL, each look-up table mapping respective color component response versus human visual tristimulus values for the at least one APL, and determining a display characterization transform based on APL using the look-up tables.

In an alternate embodiment of the present invention, a method for characterizing a display to adapt to changes in average power level (APL) includes measuring RGB color component response versus human visual tristimulus values for a plurality of average power levels (APLs), generating three-dimensional look up tables for each of the plurality of APLs, each three dimensional look up table including RGB color component response versus human visual tristimulus values for each of the plurality of APLs, determining a display characterization transform indexed based on APL for calibrating input content for a new APL by interpolation among the three dimensional look up tables; and storing the transform to permit conversion of the input content in accordance with an APL of the input content.

In an alternate embodiment of the present invention, a display system includes a screen configured to display input content at an average power level (APL) and a memory configured to store a four dimensional look up table indexed based on APL to determine a three-dimensional look up table of RGB color components versus human visual tristimulus values which provides calibrated input in accordance with an APL of the input content. A sensor is configured to determine when a change to a new APL has occurred. A processor is configured to be responsive to the sensor to interpolate between three-dimensional look up tables associated with a plurality of arbitrary average power levels (APLs) to calibrate input content in accordance with the new APL.

### BRIEF DESCRIPTION OF THE DRAWINGS

The teachings of the present invention can be readily understood by considering the following detailed description in conjunction with the accompanying drawings, in which:

FIG. 1 depicts a flow diagram of a method for characterizing a display by generating a reference transform associated with input content values which facilitates the adjustment and calibration of input content with respect to the transform in accordance with one embodiment of the present invention;

FIG. 2 depicts a setup for a display measurement and characterization as described in the method of FIG. 1 in accordance with one embodiment of the present invention;

FIG. 3 depicts a patch size versus a screen size for simulating an average power level in accordance with one embodiment of the present invention;

FIG. 4 depicts a family of display characterization look-up tables mapping RGB values to XYZ values for different average power levels (APL) in accordance with one embodiment of the present invention;

FIG. 5 depicts a diagram illustrating a procedure for determining a 4D look-up table with an average power level index in accordance with one embodiment of the present invention;

FIG. 6 depicts a block diagram of a process for a derivation of a 4D LUT for mapping APL-RGB values to XYZ values in accordance with one embodiment of the present invention;

FIG. 7 depicts a flow diagram of a method for characterizing a display in accordance with an alternate embodiment of the present invention; and

FIG. 8 depicts a high level block diagram of a display system for calibrating input content in accordance with a determined transform in accordance with one embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF PREFERRED EMBODIMENTS

The present invention advantageously provides a method and system for display characterization which facilitates the calibration of input content in response to dynamic behavior caused by changes in average power (picture) level (APL). Although the present invention will be described primarily within the context of specific displays and the use of a four dimensional look-up table, the specific embodiments of the present invention should not be treated as limiting the scope of the invention. It will be appreciated by those skilled in the art and informed by the teachings of the present invention that the concepts of the present invention can be advantageously applied in any display technology (e.g., televisions, computer monitors, telephone displays, etc) and using transforms of other types.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

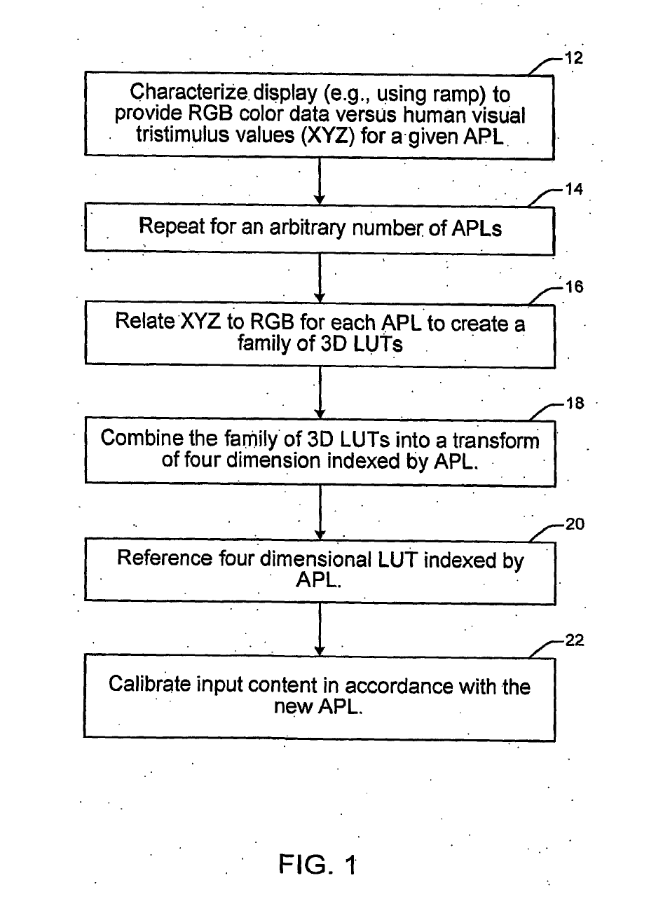

FIG. 1 depicts a flow diagram of a method for characterizing a display by generating a reference transform associated with input content values which facilitates the adjustment and calibration of input content with respect to the transform in accordance with one embodiment of the present invention. The flow diagram of FIG. 1 includes providing display characterizations for a plurality APLs and then determining a level of average power of the input content to facilitate the selection of a correct display characterization for the input content based on the average power level of the input content. The method begins in step 12, in which a characterizing for a subject display is performed. In the embodiment illustrated in step 12 of FIG. 1, the characterization includes measuring patches on the subject display using, for example, a spectroradiometer. As such, the display's maximum red, green, and blue are measured for color gamut, and white and black for brightness and contrast ratio. In one embodiment, to determine gamma characteristics, a series of patches are measured. This is called a ramp. For example, a gray ramp includes: (Red,Green,Blue)=(0,0,0), (32,32,32), (64,64,64), . . . , (224,224,224), (255,255,255)). From this information, a gamma curve (luminance vs. digital value) is obtained for each channel (e.g., R, G and B). XYZ information is obtained to compare to the RGB colors expected to characterize the display output.

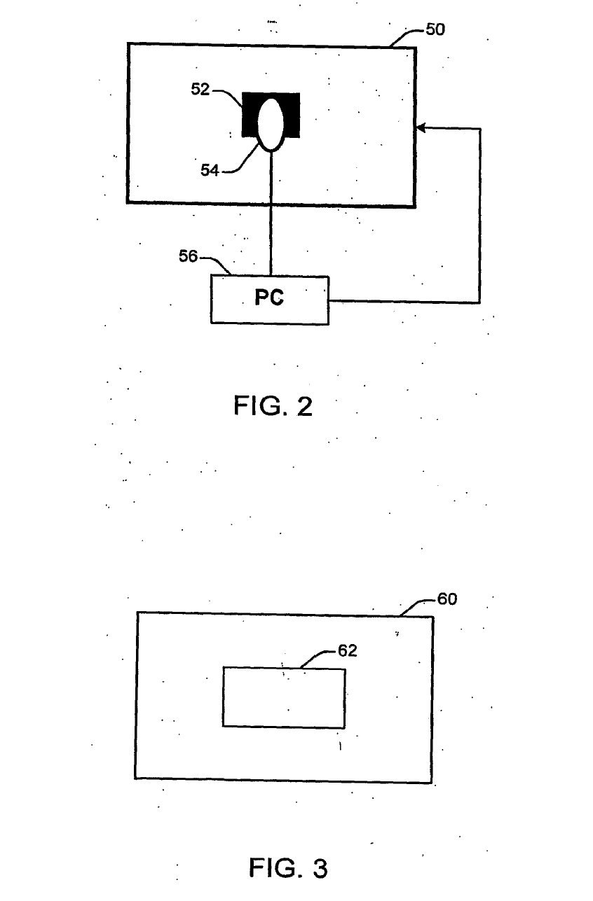

For example, FIG. 2 depicts a setup for a display measurement and characterization as described in step 12 of the method of FIG. 1, above. That is, measurement patches 52 are positioned on a display 50 in, for example the center, and are measured by a spectroradiometer 54. Measurements can include either spectral data (spectral power distribution as a function of wavelength) or colorimetric data (i.e. CIE XYZ). CIE is the international committee for color standardization and defined human visual system (HVS)'s color response function which is used to calculate XYZ tristimulus values. XYZ are numeric values to represent a color seen by human visual system (HVS). The numeric values are calculated by integrating spectrum of the color with HVS's color response function. This measurement is performed at a fixed APL (i.e., respective measurements made at a plurality of fixed APLs). The data is provided to a computer 56, which can also be used to control the display 50. Although in FIG. 2, the computer 56 is displayed as a separate component, in alternate embodiments of the present invention, the computer 56 can comprise at least a memory and a processor incorporated as part of the display 50. The method then proceeds to step 14.

At step 14, the measurements described in step 12 are repeated a plurality of times for a number of different APLs. For example, in one embodiment of the present invention, the measurement is made for ten different APLs. In one embodiment of the present invention and for description purposes, the APL value can be defined as being associated with the size of a patch centered on a display screen since the size is related to the driving power level of the display. FIG. 3 depicts a patch size versus a screen size for simulating an average power level in accordance with one embodiment of the present invention. In FIG. 3 an example patch 62 represents about 15% APL on a display 60. The measurements are preferably performed by varying the size of the patches (i.e., varying the APL; 10%, 20%, 30%, . . . , 100% APL).

As the patch size is increased (i.e., APL percentage is larger), the overall luminance is decreased, however the luminance for black is not much different (i.e., the luminance for white at 10% APL is 500 cd/m² vs. 172 m/² at 100% APL, and the luminance for black at 10% APL is 0.19 cd/m² vs. 0.16 cd/m² at 100% APL). This is a typical characteristic of recent flat-panel displays. From the measurements above, ten sets of XYZ data are obtained for ten different APL settings. Although a specific display characterization method was described in FIGS. 1-3 above, various other means and methods for characterizing a display are known in the art and such means and methods can be implemented in the present invention for characterizing a subject display. The method then proceeds to step 16.

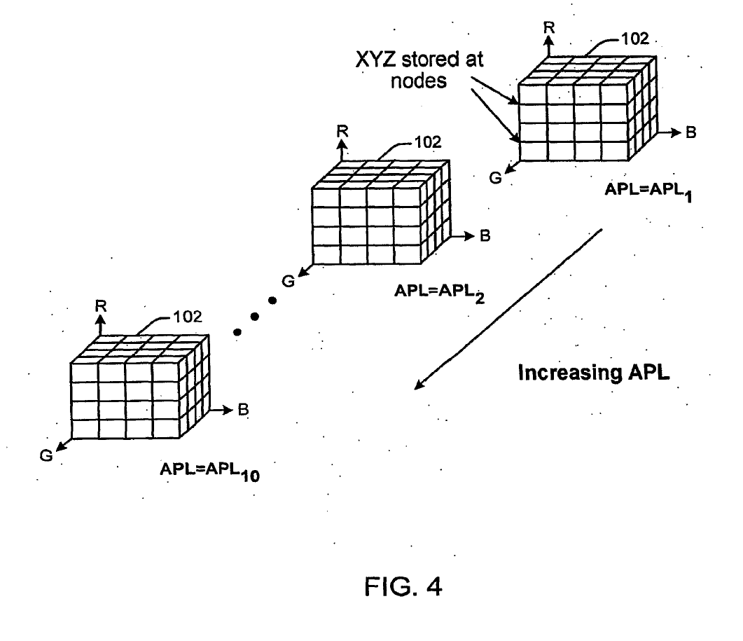

Referring back to FIG. 1, at step 16 each XYZ data set can be related to the display RGB values for the patches for a display characterization method using a 3D look-up table (LUT). For example, FIG. 4 depicts a family of display characterization look-up tables mapping RGB values to XYZ values for different average power levels (APL) in accordance with one embodiment of the present invention. In the embodiment of FIG. 4, a family of ten display characterization LUTs 102 map display RGB values to XYZ measurement values at 10 different APLs (e.g., APL₁ to APL₁₀). XYZ data are described as node values in RGB three dimensional space. At the same RGB point between characterizations, different XYZ values are stored which represent the change of the display characteristics at each measured APL value. As a result, ten different 3D LUTs are obtained. The method then proceeds to step 18.

Referring back to FIG. 1, at step 18, the family of 3D LUTs 102 is combined into, in one embodiment, a single four-dimensional look-up table (4D LUT). In accordance with the present invention, the 4D LUT maps APL-RGB to XYZ. In this regard, the APL size (value) is used as the 4^{th} dimension. This enables the determination of a display characterization transform for arbitrary levels of average power of the input content via, for example, interpolation among the pre-determined APLs characterized as described above and in accordance with an embodiment of the present invention. In various embodiments of the present invention, the transform of the present invention can be predetermined for all APL, for example, by determining a best fit curve between the 3D LUTs or can be determined by interpolation for each instance that the APL changes in a display. Although in the embodiment described above, the 3D LUTs 102 are combined into a single 4D LUT, in alternate embodiments of the present invention, the 3D LUTs 102 can be combined into one or more 4D LUTs.

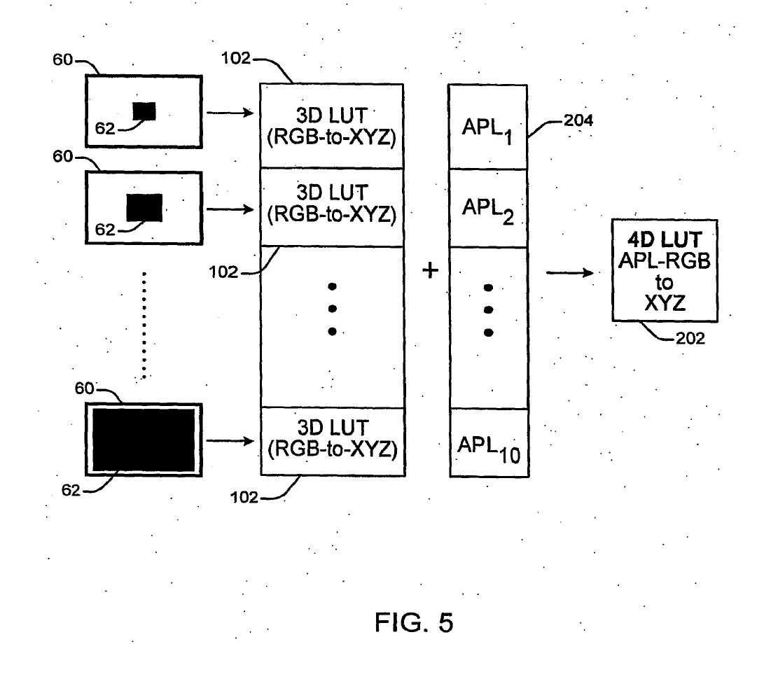

FIG. 5 depicts a diagram illustrating a procedure for determining a 4D look-up table 202 with an average power level index in accordance with one embodiment of the present invention. As illustrated in FIG. 5, APL values are tracked from the input content. For example, a range of APL values 204 are derived corresponding to arbitrary patches 62 on the display 60. As previously describe, the size of the measurement patches 62 can be representative of the APL value. In practical situations, the size can correspond to the average luminance of one frame of the content. So, for each frame, the average luminance is computed and used as the APL value, and then a resultant APL (APL₁-APL₁₀) is used to index into the respective 3D characterization 102 from RGB to XYZ. A final transform, in accordance with one embodiment of the present invention, results in a 4D LUT 202 that maps APL-RGB values to XYZ values. In accordance with the present invention, the described process can be performed on a frame by frame basis, a multiple frame basis, a scene by scene basis or any other suitable basis. The method then proceeds to step 20.

Referring back to FIG. 1, at step 20, the determined 4D LUT transform is referenced when a display's APL changes or when a different APL is selected. This can include looking up a value or interpolating/extrapolating a value from the transform (from the 4D LUT 202) to derive an appropriate mapping from RGB to XYZ in accordance with the new APL. An interpolation can be needed to determine correct 3D LUTs for the new APL value. This is because only 3D LUTs for the ten fixed APLs were derived. Assuming the transition from one APL to another provides smooth change of XYZ measurement, in one embodiment of the present invention, a standard interpolation method such as spline interpolation can be used to determine an appropriate value for adjusting and calibrating the display of the input content based upon the APL of the input content. In an alternate embodiment of the present invention, a transform curve can be created for all APLs to provide a measurement for any new APL. The method then proceeds to step 222.

At step 22, the display of the input content can be recalibrated or remapped in accordance with the appropriate RGB/XYZ transform for a new APL. That is, upon a change in APL or when a new APL is sensed, the display of the input content is adjusted according to the RGB/XYZ transform and the value of the changed or new sensed APL. More specifically, the value of the changed or new sensed APL is determined and the RGB/XYZ transform is used for determining a display value for the input content based on the value of the changed or new sensed APL and its corresponding value on the RGB/XYZ transform.

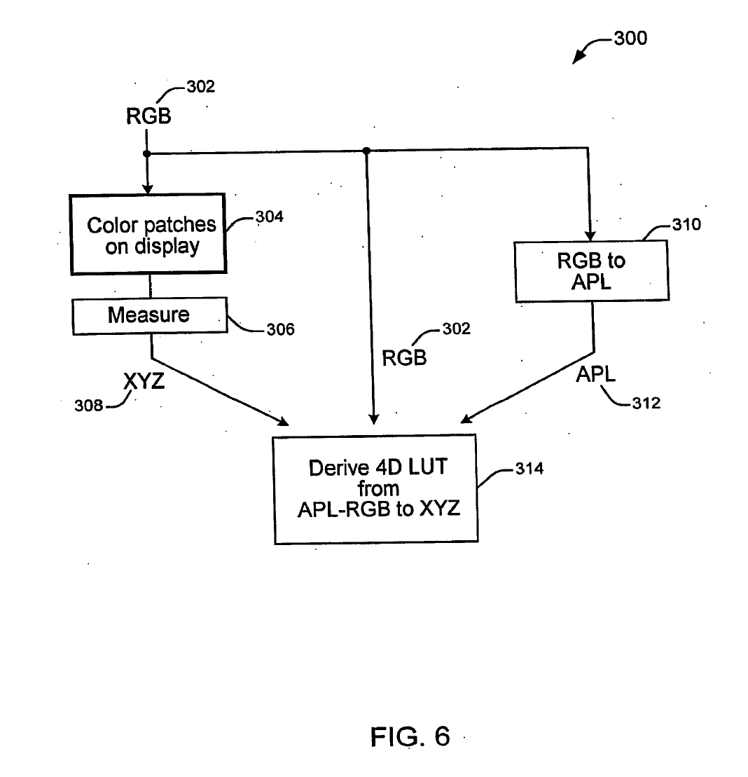

FIG. 6 depicts a block diagram of a process for a derivation of a 4D LUT for mapping APL-RGB values to XYZ values in accordance with one embodiment of the present invention. The process 300 of FIG. 6 includes obtaining RGB information 302 from the determined digital values of the patches measured on a subject display. That is, as described above, color patches 304 are provided on the display and measured 306 to provide HVS information (XYZ values 308) for the 4D LUT 314. RGB data associated with the APLs 312 are also used to determine the 4D LUT 314. In addition and as described above, the RGB data 302 is also used to determine the 4D LUT 314. The process of the present invention determines a characterization LUT for the display according to the levels of average power in the input content. As described above, it was assumed that the size of measurement patches 304 on the display center is related with the average APL. In the embodiment of FIG. 6, the measurement 306 of brightness, contrast ratio, color gamut, and gammas is performed for ten different APL sizes (10% to 100%). Then, standard 3D LUTs (mapping RGB to XYZ) are derived respectively for each APL size. In the embodiment of FIG. 6, the family of 3D LUTs is combined into a single 4D LUT 314 which maps the respective APL-RGB values to XYZ values. The 4D LUT 314 is then used, as described above, to adjust the display values of the input content in response to the APL values.

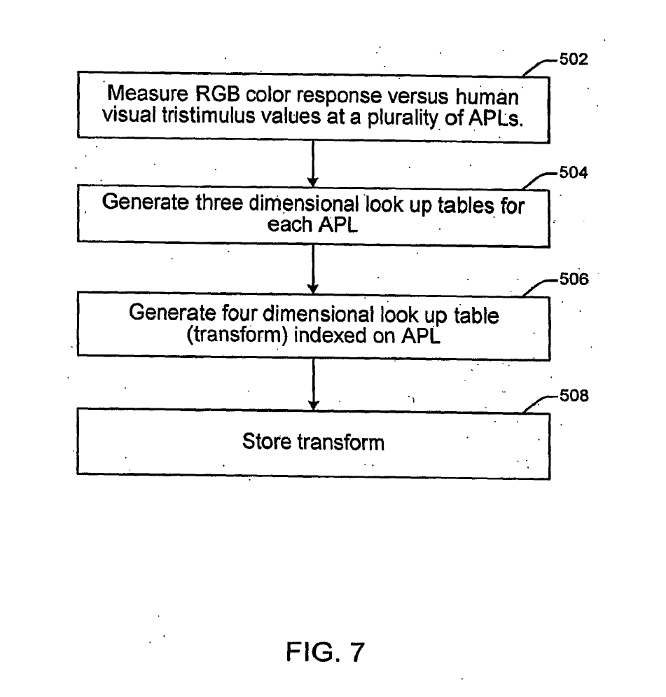

FIG. 7 depicts a flow diagram of a method for characterizing a display in accordance with an alternate embodiment of the present invention. The method of FIG. 7 begins at step 502 in which RGB color component response versus human visual system (e.g., tristimulus) values are measured for a plurality of average power levels (APLs). The method then proceeds to step 504.

At step 504, three-dimensional look-up tables are generated for each of the plurality of APLs. Each three dimensional look-up table includes RGB color component response versus human visual tristimulus values for each of the plurality of APLs. The method then proceeds to step 506.

At step 506, a display characterization transform is determined, which is indexed based on APL, for adjusting the display values of input content based on a changed or new APL by interpolation (extrapolation) among the three dimensional look up tables. The method then proceeds to step 508.

At step 508, the transform is stored to facilitate the adjustment of the display values of input content based on a changed or new APL. As described above and in one embodiment of the present invention, the transform can comprise a four dimensional table having three-dimensional look-up tables at arbitrary APLs allowing for interpolation between nearest three-dimensional look-up table values to determine display values for input content based on APL values of the input content.

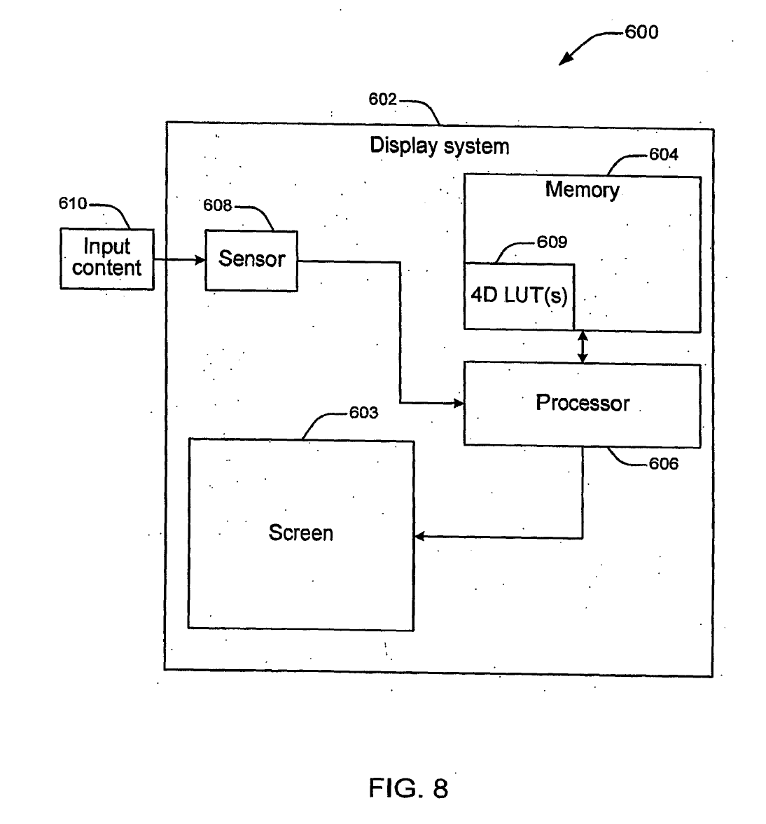

FIG. 8 depicts a high level block diagram of a display system 600 for characterizing a display and adjusting the display values of input content in accordance with a transform determined from the display characterization and determined APL values in accordance with one embodiment of the present invention. The display system 600 of FIG. 8 illustratively includes a display apparatus 602 having a screen 603, a memory 604, a processor 606 and a sensor 608. The display apparatus 602 can comprise a television, a computer monitor, a handheld display device or any other display. The screen 603 of the display apparatus 602 is implemented for displaying input content and the like. The memory 604 of the display apparatus 602 can store programs, algorithms, determined LUTs, measurement values and the like and the processor 606 of the display apparatus 602 can be used for executing the programs and algorithms stored in the memory 604 for performing the inventive concepts of the present invention. That is, the processor 606 can be used to adjusting the display values of input content in accordance with a transform determined from the display characterization and in response to a change in APL level. The APL levels can be measured and recorded by the sensor 608 of the display apparatus 602. The sensor 608 can also be used to monitor input content to determine if the APL level of the input content has changed or has been adjusted by a user. In one embodiment, a family of 3D LUTs in the 4D lookup table 609 stored in the memory 604 is used to determine a display value for input content in accordance with the new APL and as described above. This is performed dynamically during operation of the display device 602.

During operation, the display apparatus 602 is used for viewing input content 610. As APL changes are experienced in the input content, the sensor 608 alerts the processor 606 that a change has occurred. The processor 606 communicates with the memory 604 for executing the programs and information stored in the memory 604 and uses, in one embodiment, the 4D look up table 609 to adjust the display values of input content in accordance with respective values of the 4D look-up table 609 and the APL value and in response to the change in APL level.

In an alternate embodiment of the present invention, a plurality of 4D LUTs 609 can be stored in the memory 604 of the display apparatus 602 (the plurality of 4D LUTs being predetermined) and a user is given the ability to select one of the 4D LUTs based upon user preferences of a default display image feature, for example, high brightness, etc, to determine a correct value from the 4D LUT to control the look of the input content when displayed. That is, various transforms can be determined and stored (as described above) and a particular transform can be selected to control the look of the input content when displayed depending on a desired look for the display of the input content.

Having described preferred embodiments for a method and system for display characterization and content calibration (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for content display calibration, comprising
determining an average power level (APL) of said content; and
applying a transform to said content to determine display values for said content based on the determined APL of said content, said transform based on a display characterization which includes a measurement of at least one APL on the display.

2. The method of claim 1, wherein said transform maps content color values to respective human visual system values for different average power levels.

3. The method of claim 1, wherein said transform comprises a four dimensional look-up table.

4. The method of claim 3, wherein said four dimensional look-up-table maps content color values to respective human visual system values for different average, power levels.

5. The method of claim 1, wherein said display characterization includes measuring patches on said the, said patches being representative of different average power level.

6. The method of claim 1, wherein applying a transform includes interpolating between nearest average power level values of said transform to determine a display value for said content if the determined average power level value for said content is not listed in said transform.

7. The method of claim 1, wherein said display characterization comprises associating different average power levels with RGB color components as a function of human visual tristimulus values to generate respective three dimensional look-up tables.

8. The method of claim 7, wherein said respective three dimensional look-up tables are combined to form a four dimensional look-up table transform.

9. The method of claim 1, wherein determining a level of average power (APL) of said content includes calculating an average luminance of a frame of said content.

10. A method for characterizing a display to adapt to changes in average power level (APL) of input content, comprising:
measuring a color component response of said display for at least one average power level (APL);
generating a look-up table for the at least one APL, each look-up table mapping respective color component response versus human visual tristimulus Values for the at least one APL; and
determining a display characterization transform based on APL using said look-up tables.

11. The method of claim 10, further comprising storing said transform for application to input content for facilitating the determination of display values for said input content in response to an APL of said input content.

12. The method of claim 10, wherein measuring color component response includes measuring luminance values for a series of patches on said display for a plurality of different APLs.

13. The method of claim 10, wherein said transform comprises a four dimensional look-up table comprising at least one three-dimensional look up table for each APL.

14. The method of claim 10, further comprising determining a level of average power (APL) in input content by calculating an average luminance of a frame of said input content; and
referencing said transform for determining display values for said input content based on said determined APL of said input content.

15. A display system, comprising:
a screen configured to display input content at an average power level (APL);
a storage means configured to store programs and at least one transform based on measured average power levels;
a sensor configured to determine average power levels of said input content; and
a processor configured to be responsive to the sensor and to execute the programs in said storage means for applying said transform to determine display values for said input content based upon the determined APL of said input content.

16. The display system of claim 15, wherein said transform comprises a four dimensional look-up table.

17. The display system of claim 16, wherein said four dimensional look-up table maps content color values to respective human visual system values for different average power levels.

18. The display system of claim 15, wherein said transform is based on characterization of said display, said characterization based on a measurement of at least one average power level on said display, which includes measuring patches on said display, said patches being representative of different average power levels.

19. The display system of claim 18, wherein said display characterization further comprises associating different average power levels with RGB color components as a function of human visual tristimulus values to generate respective three dimensional look-up tables.

20. The display system of claim 19, wherein said respective three dimensional look-up tables are combined to form a four dimensional look-up table.

21. The display system of claim 15, wherein applying said transform includes interpolating between nearest average power level values of said transform to determine display values for said content if the determined average power level Value for said content is not listed in said transform.

22. The display system of claim 15, wherein said storage means stores a plurality of four dimensional look-up tables to calibrate said input content.

23. The display system of claim 22, wherein said four dimensional look-up tables are user selectable.
